(19) United States
(12) Patent Application Publication
(10) Pub. No.: US 2007/0192179 A1
(43) Pub. Date: Aug. 16, 2007

(54) Survey-Based Qualification of Keyword Searches

(76) Inventor: Andrew Stephen Van Luchene, Santa Fe, NM (US)

Correspondence Address: GONZALES PATENT SERVICES, 4605 CONGRESS AVE. NW, ALBUQUERQUE, NM, 87114, US

(21) Appl. No.: 11/278,123

(22) Filed: Mar. 30, 2006

Related U.S. Application Data
(60) Provisional application No. 60/774,177, filed on Feb. 15, 2006.

(51) Int. Cl. G06Q 30/00; G06F 17/30; G06F 17/00

(52) U.S. Cl. 705/14; 707/3; 707/104.1

(57) ABSTRACT

Systems and methods for survey based qualification of keyword searches and survey based qualification of keyword advertising. A searcher provides a search query to a search engine and is presented with at least one query-specific survey question. The searcher's original query and/or response to the query-specific survey question(s) are then used to generate search results.

### CROSS REFERENCE TO RELATED APPLICATIONS

The present application claims priority to U.S. Provisional Patent Application Ser. No. 60/774,177 filed Feb. 15, 2006.

### BACKGROUND

The concept of conducting internet searches is well known. Often these searches are performed when a user, or searcher, submits a search query including one or more keywords to a search engine. The search engine then provides the searcher with a listing of search results, or “hit” list. The searcher may then view one or more of the “hits,” begin a new search, or move on to another activity. In some cases the hit list may include one or more advertisements from advertisers. Improved methods for conducting internet searches are desirable.

### BRIEF DESCRIPTION OF THE DRAWINGS

FIG. 1 is a block diagram of a system for survey based qualification of keyword searches according to one embodiment of the present invention.

FIG. 2 provides a method for survey based qualification of keyword searches according to one embodiment of the present invention.

FIG. 3 is a block diagram of a system for survey based qualification of keyword advertising according to another embodiment of the present invention.

FIG. 4 provides a method for survey based qualification of keyword advertising according to one embodiment of the present invention.

FIG. 5 provides a method for survey based qualification of keyword advertising according to another embodiment of the present invention.

### DETAILED DESCRIPTION

The present disclosure provides methods and systems for conducting survey based qualification of keyword searches. For the purposes of fully understanding the presently disclosed methods and systems, it will be understood that the terms below shall have the following definitions:

Advertiser-shall mean an entity that provides an advertisement, whether or not the advertisement offers goods or services for sale.

Browser-shall mean a user interface that allows a user to interact with a networked environment. An example of a browser is the Internet Explorer® browser, offered by Microsoft, Inc (Redmond, Wash.).

Browser tool bar-shall mean a tool bar embedded in a browser such as the Google™ toolbar from Google, Inc. (Mountain View, Calif.).

Conversion Tracking-shall mean the system that is provided by a search engine, or separate application, to inform an advertiser of which (i) keyword string(s) or (ii) keyword string(s) plus answers to subsequent survey questions generated in response to submitting the keyword string to the search engine yield a successful response, as defined by the advertiser.

Keyword-shall mean any word (or portion of a word) that is (or was) typed in a search engine to generate a search or searches.

Keyword String-shall mean a group of one or more keywords

Product—any goods, services, information, or items, whether tangible or intangible, that may be made available to a searcher by an advertiser, whether offered for sale, barter, loan, or free of charge.

Search Engine—shall mean a system such as Google or Yahoo that receives a search query comprised of a keyword or keyword string from a searcher and provides website listings to the searcher based on the submitted search query.

Searcher—shall mean an individual or computer program that submits a search query to a search engine.

Survey question or questionnaire—shall mean a request for information from a searcher where the request has been triggered by a search query submitted to a search engine by the searcher. A survey question or questionnaire need not be phrased in the form of a question.

Success Criteria—shall mean any criteria defined by the advertiser indicating that a searcher has successfully performed an activity. These activities could be, but are not limited to (i) purchasing something from the advertiser's website (ii) filling out a survey on the advertisers website (iii) seeing the advertisers advertisement or (iv) going to the advertiser's or another sponsored link or website.

The term “determining” and grammatical variants thereof (e.g., to determine a price, determining a value, determine an object which meets a certain criterion) is used in an extremely broad sensey. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like.

Moreover, the term “determining” does not imply that mathematical processing must be performed, does not imply that numerical methods must be used, and does not imply that an algorithm or process is used.

Furthermore, the term “determining” does not imply that any particular device must be used. For example, a computer need not necessarily perform the determining.

Process—any process, algorithm, method or the like, unless expressly specified otherwise. Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

An embodiment, embodiment, embodiments, the embodiment, the embodiments, one or more embodiments, some embodiments, certain embodiments, one embodiment, another embodiment and the like—means “one or more (but not all) embodiments of the disclosed invention(s)”, unless expressly specified otherwise. A reference to “another embodiment” in describing an embodiment does not imply that the referenced embodiment is mutually exclusive with another embodiment (e.g., an embodiment described before the referenced embodiment), unless expressly specified otherwise.

Variation, as in “variation of an invention” —means an embodiment of the invention, unless expressly specified otherwise.

“Including”, “comprising” and variations thereof—mean “including but not limited to”, unless expressly specified otherwise.

“Consisting of” and variations thereof—mean “including and limited to”, unless expressly specified otherwise.

“A,” “an” and “the”—mean “one or more”, unless expressly specified otherwise.

Plurality—means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things)—means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies does not establish specific further limitations of the claim or otherwise restrict the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms means “that is”, and thus limits the term or phrase it explains. For example, in the sentence “the computer sends data (i.e., instructions) over the Internet”, the term “i.e.” explains that “instructions” are the “data” that the computer sends over the Internet.

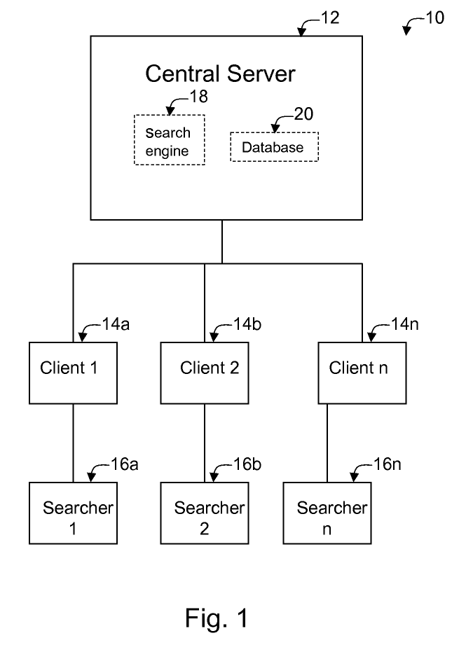

Turning now to FIG. 1, a system 10 suitable for use according to one embodiment of the present disclosure is depicted. As shown, the system includes a central server 12 which is in electronic communication with one or more client computing devices 14. Each client computing device 14 allows one or more users 16 to access central server 12. System 10 is configured such that a search engine can receive a search request from a user, retrieve search results from one or more databases, and provide the search results to the user. Numerous configurations for the locations of the search engine and databases are possible. According to the depicted embodiment, a search engine 18 and one or more databases 20 are hosted by central server 12. However, it will be readily understood that search engine 18 may, for example, be located on one or more client computing devices 14, on another server in electronic communication with central server 12, or elsewhere, so long as search engine 18 is in electronic communication with and accessible by the client computing device. Moreover, it will be further understood that databases 18 may be located, collectively, or individually, in numerous locations in the system, including without limitation, on central server 12, on a different server, on a client computer device, etc. Moreover, it will be understood that search engine 18 may be capable of accessing a first database in a first location and a second database in a second location, etc. and assembling search results from multiple databases. Regardless of the location of the search engine and databases, the user will typically access the search engine through some type of user interface such as, for example, a web browser.

Central server 12 and client computing device 14 may be, for example, appropriately programmed general purpose or dedicated computers and computing devices. Accordingly, such devices will typically include a processor configured to receive and execute instructions from a computer program. Thus, it will be understood that the various processes and methods described herein may be implemented by an appropriately programmed general or purpose or dedicated computer or computing device.

For the purposes of the present disclosure, a “processor” means one or more microprocessors, central processing units (CPUs), computing devices, microcontrollers, digital signal processors, or like devices or any combination thereof. Typically a processor (e.g., one or more microprocessors, one or more microcontrollers, one or more digital signal processors) will receive instructions (e.g., from a memory or like device), and execute those instructions, thereby performing one or more processes defined by those instructions.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

For the purposes of the present disclosure, the term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth□, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

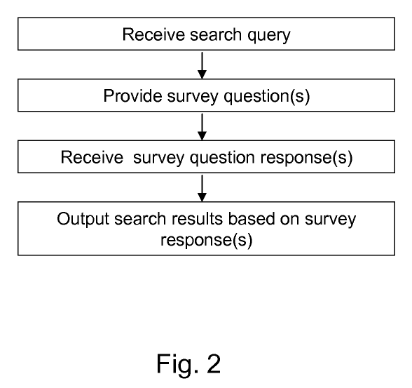

Turning now to FIG. 2, a method according to one embodiment of the present disclosure is provided. According to this embodiment, when a search query is received from a searcher, one or more survey questions are sent to the searcher. The answers provided by the searcher to these survey questions are then used to refine the search results that are provided to the searcher. For example, a searcher may input a search query of “GPS unit.” In response, the searcher may then be offered a survey question such as, “Are you interested in a Car GPS, a Boat GPS, or an Airplane GPS?” The searcher's response could then be used to provide search results that correspond to the searcher's interests.

It will be readily understood that a survey question may be offered alone or as one of a plurality of questions. If a plurality of questions are offered, the may be offered simultaneously, sequentially, or in sequential groups. For example, if a searcher responds affirmatively to the above question regarding Car, Boat, and Airplane GPS systems, the search may be provided with a second question clarifying which of these he is interested in. If a searcher responds by indicating interest in a Car GPS, the searcher could be asked an additional follow-on question such as, “Are you interested in purchasing a Car GPS unit?” If the searcher responds positively, additional survey questions could be asked and/or the searcher could then be directed towards advertising for Car GPS units.

Alternatively, or additionally, the searcher may be provided with an initial list of questions such as:

Are you interested in purchasing a GPS system?

Are you interested in purchasing accessories for a GPS system?

Are you interested in maintaining a GPS system that you currently own?

Are you interested in learning how a GPS system works?

The searcher may then be provided with links for appropriate websites or asked additional follow-on questions depending upon which question the searcher responds to, if any.

According to one embodiment, a survey question may be offered prior to search results being provided to the searcher. Alternatively, a survey question and the search results that would be generated based solely on the original search query could be provided to the searcher simultaneously. In such a case, the survey question and search results may be provided to the user in such a way that the user can easily distinguish between the survey question and the search results. For example, the survey question may be provided in a separate part of a web browser window or in a separate browser window.

According to another embodiment, once the searcher provides an answer to the survey question, new search results can be generated and displayed. According to some embodiments, new search results may be generated dynamically, such that search results, surveys, products and/or other actions may be presented to the searcher in real time as the searcher types search queries or answers into any portion of the search engine or survey questionnaire. As the searcher types search words, strings or answers or any portions thereof, the system can provide “interim” results.

It will be understood that the survey questions may be offered by the search engine. Alternatively, the survey questions may be offered by a third party that monitors queries to the search engine and then provides questions to the searcher, either directly, or indirectly, e.g. via the search engine. Accordingly, for the purposes of simplicity and clarity, the present disclosure may make reference to a “survey program.” It will be understood that the survey program may be an integral part of the search engine or may be a separate program, or group of programs, configured to work with one or more search engines. Moreover, the survey program may be operated by the entity that operates the search engine, or operated by a third party that is or is not associated with the search engine.

According to one embodiment, the present disclosure provides search methods and systems related to keyword advertising. According to one method of keyword advertising, a searcher types a keyword or search string into a search engine. Based on the keyword or search string entered, a list of advertisements is shown to the user. A certain percentage of searchers will typically select or “click on” an advertisement of interest, and are then directed to a website providing additional information related to the advertisement. According to some methods, the advertiser may pay the search engine provider some amount of compensation each time a searcher clicks on the advertisement.

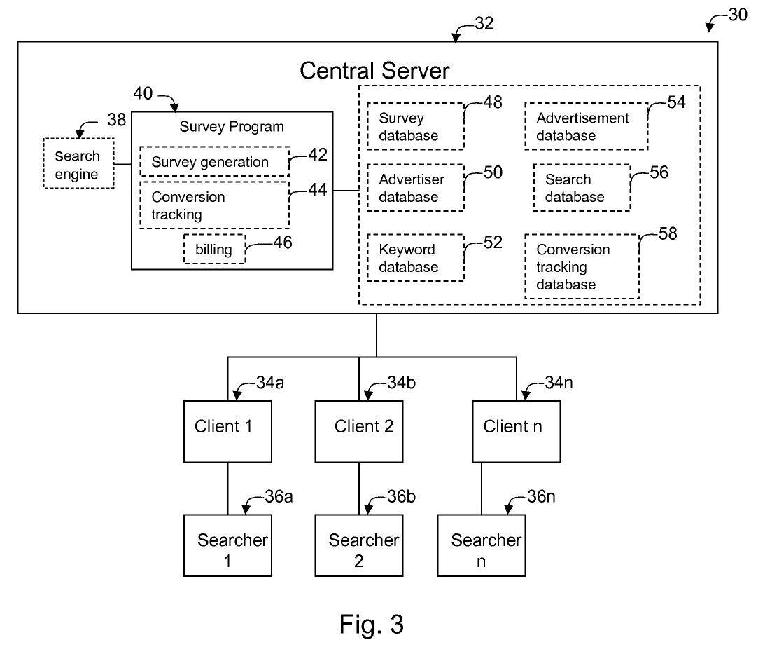

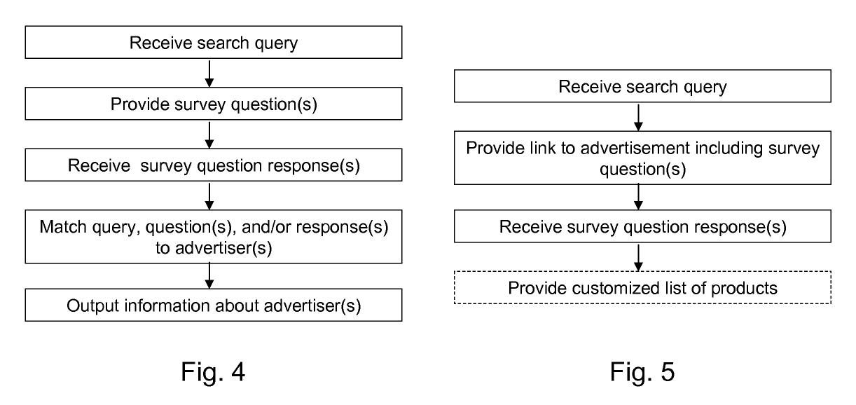

FIG. 3 provides a block diagram of a system 30 configured provide survey based qualification of keyword advertising. As shown in FIG. 4, a central server 32 is in electronic communication with one or more client computers 34, through which one or more searchers 36 are able to access programs such as search engine 38 and survey program 40, located on central server 32. It will be appreciated that while search engine 38 and survey program 40 are shown as being hosted by a single central server 32, they may actually be hosted on the same or different computers which may or may not be servers. Moreover, as explained above, survey program 40 may be an integrated part of search engine 38 or a separate program operated by the same or a different entity as the search engine. Survey program 40 may include multiple optional programs such as a survey generation program 42, conversion tracking program 44 and advertising billing program 46. Moreover, survey program 40 may be electronic communication with a number of databases such as, for example, survey database 48, advertiser database 50, advertiser keyword database 52, advertisement database 54, search database 56, and conversion tracking database and 58. While the databases are shown as being hosted by central server 32, it will be appreciated that one, some, or all of the databases may be hosted on another server, or hosted by other computers.

According to an embodiment, system 30 may be configured to allow an advertiser to select a keyword (or keywords) with which he would like to associate an advertisement. It will be understood that an advertisement in this sense may take the form of or include a link to the advertiser's website or a third party website displaying the advertiser's product. Moreover, an advertisement may take any other suitable form, as described in greater detail throughout the present disclosure. According to some embodiments, the advertiser may select the keyword(s) by purchasing the right to associate his advertisement with the keyword(s). The advertiser may select and/or purchase the keyword(s) for their exclusive or non-exclusive use (i.e. other advertisers may or may not be allowed to associate their advertisements with the selected keyword(s)).

Moreover, the advertiser may want to further qualify to which searchers he would like his advertisement shown. Accordingly, he may also select one or more survey questions that he would like asked before his advertisement is shown to a particular searcher. According to some embodiments he may pay for the right to have a given question asked to a searcher who has submitted a search query including the selected keyword. These questions may be submitted by the advertiser, suggested or provided by the operator of the survey program, or suggested or provided by a third party. Like keywords, questions may be selected and/or purchased exclusively or non-exclusively.

If an advertiser selects questions with which he would like his advertisement associated, he may also want to select answers which would either trigger showing his advertisement or not showing his advertisement. According to some embodiments he may pay for the right to have his advertisement associated or not associated with a given answer or set of answers. Answers may be selected and/or purchased exclusively or non-exclusively.

As a further embodiment, the advertiser may also specify additional criteria which, must be satisfied in order for a particular advertisement to be shown. For example, the advertiser may wish to associate a particular discount offer to searchers who fulfill certain conditions. These additional criteria may be suggested by the advertiser, the survey program provider, or a third party. Moreover, the additional criteria may be purchased or selected for the advertiser's exclusive or non-exclusive use.

According to some embodiments the advertiser may alternatively or additionally pay the operator of the survey program each time his selected question is provided to a searcher, each time a selected answer is provided by a searcher, each time his advertisement is shown to the searcher, each time a searcher access the advertiser's website (or another party's website displaying the advertiser's product) via the survey program, each time a searcher meets the advertiser's success criteria, at any other suitable point , or any combination of the above.

It will be understood that the advertiser may be allowed to limit or otherwise exercise control over his financial obligations to the survey program operator by selecting the specific criteria under which his advertisement is to be shown to a searcher. Moreover, according to some embodiments, the advertiser may further be allowed to specify a cap or not-to-exceed limit for the amount to be paid to the survey program operator. This limit may be provided for a given time period, such as a not to exceed daily, weekly, monthly, and/or yearly maximum. According to some embodiments, once the not-to-exceed limit is reached, the survey program may or may not provide the advertiser's advertisement to searchers who fulfill the advertiser's criteria.

As a non-limiting example, an advertiser who is a Hyundai dealer in Norwalk, Connecticut may purchase or otherwise select the keyword “Santa Fe.” The dealer may further purchase or otherwise select the questions “Are you interested in purchasing a vehicle?” and “Where are you interested in purchasing the vehicle.” The dealer may further purchase or otherwise select the answers “Yes” and “Connecticut or Norwalk, Connecticut,” respectively. The dealer may further specify that a searcher who has visited other car dealer websites may be provided with an advertisement offering a special discount, such as a $100 gift certificate to a local retailer, if the searcher signs up for a test drive via the advertiser's website.

Accordingly, the Hyundai dealer may have paid a one time fee to the survey program operator for the right to associate his advertising with the keyword “Santa Fe.” He may have also paid a one time fee for the right to associate his advertising with the questions “Are you interested in purchasing a vehicle?” and “Where are you interested in purchasing the vehicle.” He may then pay a given amount to the survey program operator each time a searcher returns the answers “Yes” and “Connecticut or Norwalk, Connecticut,” and his advertisement is shown. Of course it will be understood that various other payment schemes are possible.

Returning to FIG. 3, survey database 48 may be used to maintain and track survey questions. The survey database may maintain and associate data such as survey ID, survey questions, survey answers, keyword string, survey question sequence, survey question conditions and the like. For example, in the car dealer example above, the survey database would be used to associate the Hyundai dealer with the keyword “Santa Fe,” the question “Are you interested in purchasing a vehicle?” with the answer “Yes” the question “Where are you interested in purchasing the vehicle?” with the answers “Connecticut” and “Norwalk Connecticut.” Moreover, the database may also indicate that the question “Where are you interested in purchasing the vehicle” should only be asked if the searcher has answered “Yes” to the question, “Are you interested in purchasing a vehicle.”

Advertiser database 50 may be used to maintain and track information regarding advertisers who use the survey program's services. The advertiser database may maintain and associate data such as advertiser ID, advertiser personal information, advertiser billing information, a maximum daily spending limit, a maximum monthly spending limit, and the like.

Accordingly, in the Hyundai dealer example above, the advertiser database may include information about the Hyundai dealer such as contact name, address, credit card number, and not to exceed limits on advertiser spending, etc. Each advertiser may be assigned specific identification indicia (e.g. numbers, letter, symbols, or combinations thereof) that is used by the system.

Advertiser keyword database 52 may be used to associate selected keywords with advertisers and information regarding the association. The advertiser keyword database may maintain and associate data such as keyword ID, keyword name, survey question, survey answer, survey question conditions, maximum price to ask question in response to keyword string, advertiser ID, maximum price per click, maximum price per email, maximum price per displayed advertisement, and the like.

Accordingly, in the Hyundai dealer example above, the advertiser keyword database may associate the keyword “Santa Fe” with the questions provided above. Moreover, the database may further indicate that the dealer is willing to pay, at most, $0.10 to have the question “Are you interested in buying a car?” asked and $0.25 to have the question “Where do you want to buy the car?” asked. (It should be noted that according to some embodiments, the second question will only be asked if the first question is answered affirmatively.) The database may further indicate that the dealer is willing to pay a maximum of $0.25 each time an email including a link to his website is sent to a searcher, $0.25 each time his advertisement is displayed to a searcher and a maximum of $0.50 each time a searcher accesses his website via the survey program's services. The database may further indicate that the dealer is willing to pay a maximum of $5 each time a first success criteria is met, e.g. the searcher schedules a test drive through the searcher's website after accessing the website via the survey program and a maximum of $100 each time a second success criteria is met, e.g. the searcher purchases a car from the dealer.

Moreover, according to some embodiments, these maximum amounts may be altered, for example by the advertiser or the survey program, over time in accordance with the level of success, or lack thereof, a given survey question(s)-keyword combination brings to the advertiser.

Advertisement database 54 may be used to maintain and track the advertisements that are provided by the survey program in response to searcher queries. The advertisement database may maintain and associate data such as advertisement ID, advertisement text, advertisement website address, advertisement conditions, advertisement triggering keywords, advertisement triggering survey questions, advertisement triggering survey answers, advertisement triggering conditions, discount offers, discount offer triggering conditions, and the like.

Accordingly, in the Hyundai example above, the dealer may provide the survey program with multiple advertisements. For example, the dealer may provide the survey program with a first advertisement simply providing information about the vehicle and the dealership, a second advertisement offering a $100 gift certificate if the searcher schedules a test drive via the website (and then subsequently shows up for the test drive), and a third advertisement offering $500 cash back to a searcher who comes to the dealership and purchases a vehicle that day. The advertisement database may further include information determining which specific keywords, questions, answers, and or other conditions would trigger each of the advertisements to be provided to the searcher. For example, a searcher who enters a search query of “Santa Fe” and “test drive” and answers affirmatively that he is interested in purchasing a vehicle and is in Norwalk, Connecticut, may be directed towards the advertisement offering $500 cash back, since he appears to have a clear interest in purchasing the car. Alternatively or additionally, a searcher who has accessed the advertiser's website multiple times within a given time period, say three times in the last two weeks, may be directed towards the second advertisement offering the $100 gift certificate as an extra inducement to come to the dealership.

Search database 56 may be used to track the search queries that triggered the survey program's services and the subsequent behavior of the searcher. The search database may maintain and associate data such as search ID, keyword string, survey generated, survey answers, advertisements displayed, advertisements selected, conversion data, transaction data, and the like.

Returning to the Hyundai dealer example, the dealer may agree to a condition that he will increase his payments by a given amount (e.g. $0.10, 25%, or the like), for each keyword, question, and/or answer that can be shown to be directly linked to a certain number of vehicles sold within a given time period (e.g. 5 vehicles sold in a month). The search database may be used to track this information so the survey program can determine whether the Hyundai dealer's payments should be increased and by how much.

Conversion tracking database 58 may be used to track success rates, as described in greater detail below. The conversion tracking database may maintain and associate data such as keyword ID, advertiser ID, time period and date, # of times a keyword has been entered, # of times an appropriate survey answer was received, # of keywords with appropriate answers who selected advertisement, # of keywords with appropriate answers who selected advertisement that also performed success criteria, # of keywords with appropriate answers who selected advertisements that also made a purchase from the specified advertiser website, and the like.

Again, in the Hyundai dealer example, the Hyundai dealer may be interested in determining which keyword, question and answer combinations are successful and which are not. He may use this information to change his keyword, question, and answer preferences, to determine whether or not and how much to pay for each keyword, question and/or answer, and/or for any other purpose. The conversion tracking database may be used to provide this information to the advertiser, the survey program operator, and or any other interested party.

It will be appreciated that the above databases and database descriptions are provided as non-limiting examples only and that the actual architecture of the system will be largely dependant on the actual system and methods being implemented and could include some, none, or all of the above databases and information in combination with any other databases and information, as necessary or desired.

FIG. 4 provides a method of survey-based qualification of keyword advertising. According to the depicted embodiment, a search engine receives a search query from a searcher. A survey question is then provided to the searcher. Based on the searcher's response to the survey question, one or more advertisements are then provided to the searcher.

According to some embodiments, the advertiser may pay the survey program provider some amount of compensation each time a searcher clicks on the advertiser's advertisement. Alternatively, or additionally, and as will be explained in greater detail below, the advertiser may pay the survey program provider upon the completion of any particular milestone in the process. For example, and without limitation, the advertiser may pay the survey program provider to use survey questions submitted by the advertiser, each time a searcher receives a survey question submitted or selected by the advertiser, each time a searcher answers a survey question submitted or selected by the advertiser, each time a searcher answers a question related to the advertiser's good or services, each time a searcher gives a specific answer in response to a survey question, when a searcher purchases a service or product after accessing the advertiser's web site via the survey program's services, to appear as part of any interim results, for information gathered by the survey program, or any combination thereof.

It will be appreciated that survey questions may be generated in any suitable method and by any suitable party. Accordingly, the survey program may be provided with a list of questions and the means to match certain keywords found in search queries to certain questions. For example, the survey program may have access to a survey question database containing any number of questions. Each question may be associated with at least one keyword. Accordingly, when a search engine receives a search query, the survey program may search the survey question database for any matched survey questions, i.e. survey questions that are associated with the keyword(s) appearing in the search query. If a matched survey question is found, the survey program may submit the matched question to the searcher. If more than one matched survey question is found, the survey program may submit one, some, or all of the matched questions to the searcher.

Questions may be developed by any entity or combination of entities capable of doing so including, without limitation, the survey program operators, the advertisers, or a third party consultant hired by the survey program operators or the advertisers. The operators of the survey program may develop questions based on a variety of factors, including, but not limited to, their client lists, past performance, known interests from searchers, etc. For example, a search engine which advertises itself as being a top search engine for car buyers may develop questions related to the make, model, and options of the cars that are offered by advertisers who have paid to use the search engine's services. Alternatively or additionally, advertisers may provide a list of questions they would like submitted to searchers who use a specific keyword or phrase in their search queries or who fall into some other identifiable category.

As a further alternative, questions may be automatically generated with or without human input by a computer program. For example, a survey (or other) program may automatically generate survey questions “on the fly” based on the appearance of one or more keywords in a search query. For example, the survey program could be configured to automatically respond to any query including a known commodity with the question “Are you interested in purchasing a (insert name of known commodity).” Alternatively, more sophisticated methods for automatically generating survey questions could be employed. Methods for automatically generating search questions based on patterns of speech are described, for example, in Allan and Raghavan, “Using Part-of-speech Patterns to Reduce Query Ambiguity” In Proceedings of the ACM Conference in Information Retrieval (SIGIR), pages 307-314 (2002), which is hereby incorporated by reference in its entirety for all purposes.

As stated above, advertisers may pay the survey program provider to use those questions and/or to match certain keywords to specific questions (regardless of who developed the question) and/or advertisements. Alternatively, or additionally, advertisers may bid for the right to have certain keywords matched to their questions and/or advertisements.

It will be appreciated that in many cases, a given search query may be associated with multiple survey questions. In such a case, the survey program could provide all or a subset of the matched questions to the searcher. If the survey program is configured to provide a subset of the matched questions to the searcher, the survey program could be configured to select the subset of matched questions based on any number of desired factors. For example, the matched questions could be prioritized based on which questions have proven to be statistically more successful in the past, which questions advertisers have paid, or bid, more for, which questions have previously been answered by this or another searcher, etc. Alternatively, the survey program could be instructed to select one or more matched questions at random. As a further alternative, the survey program could be configured to select a set of matched questions conforming to a variety of factors. For example, the survey program could be configured to select one question with a known high success rate, one question from a high-paying advertiser, and one question at random. It will be appreciated that numerous other variations and combinations are possible and that all such variations and combinations are contemplated by the present disclosure.

As a further embodiment, the survey program may only ask a single or a few questions from each user, but, aggregate the information across a large number of users. The survey program can then learn what questions matter and don't matter over time. Accordingly, the survey program could select a few questions from a very large survey, so that, with use, only the important questions are asked, but all questions are answered by a large population. Using traditional statistical methods, the survey program could operate as if every user is answering every question. Furthermore, once the survey program determines which questions apply to which search strings, irrelevant questions can be eliminated from the survey question pool, making those question(s) asked much more likely to yield desirable results.

According to another embodiment, questions may be generated based on stored answers to previously presented questions. For example, the survey program may be configured to generate and output a list of questions in response to a keyword string and then receive and store the responses to the questions. The survey program could then be configured to generate survey questions based on previously stored answers. As a non-limiting specific example, the survey program may be initially configured to respond to a search query containing the keyword “Santa Fe” with the questions “Are you interested in purchasing a vehicle?” and “Are you interested in Santa Fe, N. Mex.?” Searchers who indicate that they are interested in Santa Fe, New Mexico may be asked additional questions regarding their interest, e.g. in a vacation, in skiing, in art galleries, etc. The survey program may determine, over a period of time, that a large percentage of searchers who input the keyword “Santa Fe” are interested in Santa Fe ski vacations. Thus, instead of requiring these searchers to answer a series of questions, the search program (or advertiser) may determine that it is expedient to include the question, “Are you interested in a Santa Fe ski vacation?” as one of the initial question provided in response to the search query “Santa Fe.”

Moreover, the survey program may generate a list or survey questions that are to be provided in a particular order, depending upon the answers that are provided by the searcher. Accordingly, according to another embodiment, the present disclosure provides a method for generating and providing survey questions. The method includes generating and outputting a list of survey questions in a particular order and with a particular sequence. The method further includes receiving and storing responses to the questions. The method still further includes generating subsequent survey questions based on previously stored answers.

According to another embodiment, the survey program may be configured to track success rates for different survey questions. A success may be a searcher clicking on an advertisement, purchasing an item, providing information to an advertiser, or any other behavior identified as successful by the advertiser. The survey program may be configured to identify when and how often a particular question leads to a success. As such, the survey program and advertisers may be able to identify those questions that more accurately predict whether a searcher is interested in their products and services. Accordingly, advertisers may be willing to pay increased prices for specific questions or keywords which are known to have a high success rate for their business.

Moreover, in an embodiment where the survey program provider receives payment when a searcher subsequently makes a purchase from the advertiser website, the survey program can manage the system of questions to refine a search so that a searcher is directed to an advertiser's website with the greatest likelihood that the searcher will purchase something from that website. The survey program may use a manual or Al tool that tracks the survey questions and corresponding answers that yield the greatest or most probable likelihood that the searcher will make a purchase from the advertiser website. The survey program can track which searchers make a purchase from an advertiser's website once the searcher has selected an advertiser's advertisement. When a purchase is made from the advertiser's website, the advertiser account may be charged a fee by the survey program.

According to one embodiment, an advertiser can select or enter a certain x number of questions and corresponding acceptable answers to ask in response to a keyword string submitted by a searcher. The central system can randomly or systematically ask the questions in response to subsequent keyword strings submitted by later searchers. A conversion tracking system can track which keyword strings plus which answered questions (and in which order) yield the greatest percentage of customer conversions. For example, the keyword string “gps unit” combined with an answer “yes” to a subsequent question in a survey of “are you interested in a gps for your car today?” could yield the highest percentage of searchers who subsequently click on an advertisement and make a purchase from the advertiser's website.

Accordingly, the present disclosure provides a method for providing a limited number of questions in response to a search query including a specific keyword string. The method may include, for example, receiving a search query including keyword that has been associated with an advertiser, retrieving a list of potential survey questions to output in response to the keyword string, prioritizing the list of questions based on the price the advertiser is willing to pay for each question (or some other factor), determining a maximum number of questions to ask the searcher, and outputting the maximum number of questions in order of priority. The maximum number of questions to be output may be determined, for example, by the maximum amount of money the advertiser is willing to pay, by a predetermined number set by the advertiser or the survey program, or by other factors.

An example of another factor that could be used to prioritize the list of questions to ask the searcher is the answers that have been previously, or are usually, received from previous survey questions generated in response to the same keyword string.

Conversion tracking may include, without limitation, the keyword string input by the searcher, the survey question asked, the searcher's answer, and the searcher's subsequent behavior (e.g. which sites were visited, the order of the sites visited, whether goods or services were purchased, whether the searcher requested any additional information, etc.) Using conversion tracking the survey program may also identify the order of questions asked. In this way a survey question tree structure could be set up initially, and then dynamically rearranged so that conversion probabilities are maximized.

Moreover, any of the above-described embodiments can be enhanced by adding additional search enhancement options to them such as tracking searcher demographic and/or historical search behaviors. This information can then be used to modify surveys based on the searcher profile and search history that is stored with the central server.

As a further embodiment, the survey program could provide the information gathered from the searcher's survey answers to one or more advertisers. Advertisers could use this information in any number of ways including, for example, to develop more focused directed-advertising campaigns, to create lists of potential customers, to develop their goods and services etc. The information could be provided to the advertiser in any number of ways. For example, each completed survey that triggers the advertiser's advertisement could be sent to the advertiser. If the survey contains contact information regarding the searcher, the advertiser could use this information to contact the searcher directly. Alternatively or additionally, completed surveys that lead to a successful transaction could be forwarded to the advertiser. As a further alternative, the survey program could be configured to compile statistical data regarding searchers, searcher behavior, keywords, success rates, and the like and forward this information, with or without personal information related to the searcher(s) to the advertiser. According to a further aspect of this embodiment, advertisers could pay a fee for this information. Various fee schedules could be adopted depending on various factors such as, without limitation, the type and amount of information collected by the survey program, the type and amount of information provided to the advertiser, and the rate or likelihood of a successful transaction based on the information provided by the survey program.

With questions that are known to yield a higher rate of success, advertisers may be more inclined to pay more to be associated with these questions. Accordingly, in one embodiment, the survey program may provide differential pricing schemes for different questions or keywords. This differential pricing scheme may be based on a question's or keyword's known (or expected) rate of success or other factors. Moreover, the survey program may be further configured to receive bids, auction-style or otherwise, from advertisers desirous of associating their advertisements with specific questions or keywords.

According to another embodiment, advertisers could pay to have a question that they want to ask to be included in a list of no more than x questions that are compiled into a survey and output to a searcher in response to submitting a keyword string for search. Moreover, advertisers could specify the specific answer or answers to the questions that would serve as a trigger to provide the searcher with a link to the advertiser's advertisement and/or website. Depending on the pricing scheme, this could be done to reduce the advertiser's potential costs or for other reasons.

It will be appreciated that numerous methods of selecting survey questions may be used and that any suitable method may be used. Furthermore, the suitability of a method may be dependant upon the intents and purposes of the particular survey program and/or advertisers associated with the particular survey program. For example, a survey program that receives payment from an advertiser every time that advertiser's advertisement is clicked may be more inclined to preferentially display questions provided by or related to an advertiser who pays more per click.

As stated above, a survey question may be provided prior to or simultaneous with the delivery of search results by the search engine. It will be appreciated that more than one survey question may be given to a user at one time and that questions may be provided and answers received in any suitable format. For example, the question above, “Are you interested in a Car GPS, Boat GPS, or Airplane GPS?” may be provided as a single question with a yes or nor response button. Alternatively the same question may provided with an open ended answer blank in which the searcher may type any response. Alternatively, the question may be provided with check boxes, selectable radio buttons, or the like, which allow the searcher to select one or more responses. Furthermore, the same information may be requested in the form of three separate questions, e.g. Are you interested in a Car GPS? Are you interested in a Boat GPS? Are you interested in an Airplane GPS? Moreover these questions may be presented in a format other than as a question. For example, “Please choose the option listed below that most closely resembles your interests . . . . ” Thus it will be understood that questions and answers may be provided in a myriad of formats that are too numerous to list in any detail and that any suitable format is contemplated by the present disclosure.

Once a response has been given to a survey question, additional follow on questions may be given. Such questions may be provided for a variety of reasons, including, without limitation, to further narrow the search results to be provided to the searcher or to gather additional information about the searcher.

For example, a searcher who has indicated interest in purchasing a car GPS system may be asked, “Are you interested in purchasing a car GPS system today.” If the searcher responds positively, he may be provided with a link to a web page advertising a special price that is good for “today only.”

Alternatively or additionally, a searcher who has indicated interest in purchasing a car GPS system may be asked to provide his address, phone number, email address and/or other contact information. This information may be retained by the survey program and/or provided to one or more advertisers, for example, so that representatives from companies offering GPS systems may contact the searcher to answer questions, provide additional information, transact a sale, etc.

According to another embodiment, the survey program may be configured to generate a list of advertisers in response to the search query and survey question answers provided by the searcher. The list of advertisers could be delivered to the searcher using any suitable means. Examples of ways in which the list of advertisers could be provided to the searcher include, but are not limited to, as part of the search engine's search results, on the same page, but separate from, the search engine's search results, as (or part of ) a third party website, as (or part of) a pop-up window, in an email or text message sent to the searcher, in an automated phone call to the searcher and/or via regular mail routes. The list could provide contact information and/or, if in electronic form, be hyperlinked to the advertiser's websites. If in a form capable of supporting such features, the list could include text, audio and/or video.

According to yet another embodiment, the survey answers could be sent to a number of relevant advertisers who could then market directly to the customer. In this embodiment, the survey would include personal information provided by the searcher. For instance, the searcher could provide his or her email or mailing address as part of the survey answers, and advertisers could use that information to correspond with the searcher.

Accordingly, the present disclosure provides a method according to an embodiment for providing the survey answers to relevant advertisers. The method may include providing a survey to a searcher in response to a search query, receiving an answer to the survey, determining relevant advertisers based on the survey answer, and outputting the relevant survey answers to the relevant advertisers. Accordingly, advertisers could indicate which keywords, questions, and answers they want associated with their products and then pay to have information about searchers who have provided the appropriate keywords and question answers, forwarded to them.

FIG. 5 provides yet another method according to an embodiment of the present disclosure. According to this embodiment a search engine receives a search query from a searcher. In response to the search query, the search engine provides the searcher with links to advertisements related to keywords or phrases in the search query. Upon selecting one of the advertisements, the searcher is directed to a website offering survey questions. According to a further embodiment, responses to the survey questions are then used to provide a customized list of products, services, resources or other information in which the searcher has an interest.

As a non-limiting example, a searcher interested in planning a vacation to Santa Fe, N. Mex. can enter the terms “Santa Fe vacation” into a search engine such as the Yahoo® Search engine provided by Yahoo, Inc. (Santa Clara, Calif.). Included in the Yahoo search results is a short list of sponsored links. One of these sponsored links could advertise a trip planner to help vacationers plan their trips. A searcher could click on this link and be directed to a website providing a survey that allows the searcher to indicate various activities of interest, accommodation preferences, and the like. Upon completing the survey, the searcher could be provided with a personalized list of advertisements from providers or goods and services related to the searcher's indicated interests as well as other relevant information. The personalized list could be provided to the searcher using any known means including, for example, as part of a web page, in an email, in the mail, as a text message, on the phone as a recorded message, via a live phone operator, etc. In this embodiment, advertisers may pay to have their advertisements (and/or questions) associated with the survey program's website.

As a further embodiment, portions of the survey could be pre-selected for the user based on the terms included in the user's keyword search. For example, a user may provide a search query for “destination wedding.” The survey program may be configured to ask “Are you interested in a destination wedding” for any search query including the term “wedding.” In this case, the survey program may be configured to provide this question (with or without other questions) with a pre-selected answer (e.g. a corresponding radio button is already selected, a drop-down menu is already selected to “yes”, etc.) because the term “destination wedding” appeared in the search query.

According to yet another embodiment, advertisers could provide special incentives, discounts, promotions or the like to searchers who purchase or otherwise complete a successful transaction while or after using the survey program's features. For example, advertisers could pay to have their product listed for purchase with a discount or other promotion valid only at the time of the search. Such promotions could be limited, for example, by time, to that specific search, etc. In this embodiment, a promotional offer may be made to the searcher based on the keyword string he enters and his responses to the subsequent questions generated by the survey program on behalf of the advertiser. Accordingly, the advertiser may specify the specific answers to the survey questions that a searcher would need to answer in order to be able to view and/or take advantage of the promotional offer. The advertiser could further specify a promotional offer such as a dollar or percent discount off of the purchase total that will be provided to the searcher who clicks on the advertisement.

Accordingly, another method according to one embodiment of the present disclosure provides for providing a survey in response to a search query, determining if a promotion is available based on the survey answer(s), outputting the promotion if available, receiving an indication that a purchase has been made, applying the promotion to the purchase, and storing information related to the usage of the promotion.

According to one method of implementing this embodiment, when a searcher makes a purchase from a website that he has accessed via an advertisement provided by the survey program, the system may check to see if a discount is available based on the advertisement that was clicked by the searcher. If a discount is available, the discount may be applied to the purchase total while the searcher is checking out. The discount can be applied to the searcher's transaction based on conditions such as whether or not a particular SKU or product is in the transaction.

As a specific, non-limiting example, a searcher who enters “GPS Unit” and responds affirmatively to the question “Are you interested in buying a GPS unit today?” could be shown an advertisement generated by the survey program on behalf of the advertiser that says “Buy a GPS unit today and receive 20% off. Just click on this advertisement to receive your discount.” If the searcher clicks on the advertisement, he is directed to the advertiser's website. If he purchases the GPS unit immediately, the discount may be automatically applied to the transaction after confirming his eligibility.

Alternatively, a survey question need not necessarily be provided before displaying an advertisement with a discount. In this embodiment, the search engine could automatically generate an advertisement displaying the promotion in response to a search query including specific keywords or phrases. For example, a searcher typing “Garmin 2610” into a search engine could see an advertisement that says: “Purchase a Garmin 2610 now and receive a free battery charger.” If the searcher clicks on the search engine-provided advertisement, the searcher is redirected to the advertiser's website. If the searcher initiates a purchase of the Garmin 2610, a program could determine the searcher's eligibility for the promotional item by determining if he accessed the advertiser's website via the search engine-provided advertisement, as well as any other advertiser—or search engine-specified eligibility factors, and the additional item could be added to the transaction.

According to yet another embodiment, the advertiser could select the keyword string, question(s) and answer(s) they want associating with their advertising. In this embodment, a searcher would have to input the advertiser-selected keyword, receive the advertiser-selected survey question (or questions), and respond in the way previously indicated by the advertiser before being directed to the advertiser's website. For example, a searcher may submit the search query “Santa Fe vacation” and receive the following questions from the survey program:
i. Are you interested in planning a vacation to Santa Fe, N. Mex.?
ii. What type of accomodation are you interested in?
iii. Please tell us the dates of your trip.

A searcher who responds by saying that he is interested in planning a vacation to Santa Fe, New Mexico, that he is interested in staying at a Bed and Breakfast and that he would like to be there between December 30 and January 2, might be directed to a specific Bed and Breakfast website offering special holiday rates or inviting them to a New Year's Eve celebration. Conversely, a searcher who indicates that he is interested in planning a vacation to Santa Fe, N. Mex., that he is interested in staying at a Bed and Breakfast and that he would like to be there between April 1 and April 7, might be outside of the parameters specified by the first Bed and Breakfast and would therefore be provided with different search results.

In this way, a Bed and Breakfast with lots of openings for one period of time but that is completely booked during another period, can set up the survey program so that it will only be changed for searchers who are interested in booking rooms during the time period when the Bed and Breakfast has availability.

Accordingly, another method according to one embodiment of the present disclosure provides for receiving a survey answer in response to a survey generated by a search query, outputting a list of products available for purchase, and receiving an indication that a product was purchased. The method may further provide for determining a billing amount, and billing the advertiser the billing amount.

In an alternate embodiment, a product or list of products can be offered for sale and purchased by a searcher in response to the combination of a keyword string and a completed survey. In this embodiment, a list of products would be retrieved from a database in response to the submitted keyword and survey answers. The list of products would be made available to the searcher on a website. The customer could select one of the products and place it into a virtual shopping cart for purchase. Advertisers could pay to have their product listed for purchase.

According to another embodiment, the searcher can place his search request by entering his request via a keyboard into a web browser, speaking his request into an IVRU, or using any other means of transmitting a search query to a search engine. For example, a customer searching for a place to eat while he is driving down the road, may enter a request for nearby restaurants into his GPS unit. The GPS unit may output a survey to further specify what types of food the searcher is interested in eating. The searcher may further refine his search request by indicating, for example, that he wants to eat at a table dining restaurant that serves Japanese food. The searcher may then be provided with information about a local Japanese restaurant that has paid the browser to have their advertisement, along with directions to the restaurant output to the searcher.

Accordingly, another method according to one embodiment of the present disclosure provides for receiving a search query including a keyword string and a geographic location; generating a survey based on the geographic location and the keyword string, outputting the survey, receiving an answer, and outputting an advertisement based on the answer. The method may further provide for receiving an indication of interest to the advertisement and outputting directions associated with the advertisement or advertiser. The method may still further provide for determining a billing amount and charging the advertiser the billing amount. According to one embodiment the billing amount may be charged to the advertiser's account.

According to another embodiment, a subsequent search result lists could be output to the customer (i.e. via email) at a later time. For instance, a customer taking a survey about vacationing in Santa Fe could instantly receive an email listing vendor advertisements related to her trip and could then receive another email two weeks before the trip dates with a refreshed list of vendor advertisements.

According to another embodiment, when no survey is required, the system can simply list the advertisers using conventional means. When the number of multiple, disparate matches, i.e., types of vendors, is returned from a given search, the survey can be dynamically modified to include questions as necessary to help include or exclude particular vendors.

Accordingly, another method according to one embodiment of the present disclosure provides for receiving a keyword string, generating a survey and a list of advertisements, outputting a survey and a list of advertisements, receiving an answer to the survey, generating an additional survey and/or a list of advertisement, and outputting an additional survey and a list of advertisements.

According to another embodiment, a method for billing an advertiser for obtaining services from a survey program is provided. According to this method, a survey program may receive from a searcher a search query including a keyword which the survey program has associated with a given advertiser. The survey program may then output a survey including one or more survey questions. The survey program may then receive the searcher's answers. The survey program may then determine if the answers correspond to the answers that are associated with an advertisement provided by the given advertiser. If the searcher's answers correspond to the advertiser's advertisement, the survey program may output the advertisement to the searcher. The survey program may then determine whether the searcher clicks on the advertisement. If the searcher has clicked on the advertisement the survey program may retrieve the billing information for the advertiser, determine how much the advertiser should be billed, and bill the advertiser the appropriate amount.

Additional exemplary embodiments are described with respect to the following enumerated sentences:

1. A method comprising: receiving a search query from a user; determining a keyword in the search query which is associated with an advertisement; providing a survey question to the user to determine if the user is interested in the product; receiving a response to the survey question from the user; and providing a link to the advertisement based on the received response.

2. The method of sentence 1further comprising providing search results based on the response.

3. The method of sentence 2further comprising providing search results based on the search query.

4. The method of sentence 1 further comprising determining whether the user clicked on the link.

5. The method of sentence 4 further comprising charging a fee if the link is clicked.

6. The method of sentence 4 further comprising determining whether the user purchased a product from the website.

7. The method of sentence 6 further comprising charging a fee if a product is purchased from the website.

8. The method of sentence 4 further comprising, for each survey question, determining the frequency with which the link is clicked when the survey question is provided to the user.

9. The method of sentence 7 further comprising, for each keyword-advertisement association, determining the frequency with which the link is clicked when the survey question is provided to the user.

10. The method of sentence 9 further comprising identifying the frequency with which a product is purchased from the website.

11. The method of sentence 10 further comprising increasing the fee if the frequency with which a product is purchased meets a condition value.

12. The method of sentence 1 further comprising asking a second survey question based on the response to the first survey question.

13. The method of sentence 1 further comprising providing search results based on the responses to the first and second questions.

14. The method of sentence 1 wherein the step of providing a link to the advertisement comprises providing a promotional offer conditioned upon following the link.

15. A method comprising: generating a question configured to determine if a respondent has an interest in a product; determining a search query having a probability of being related to the product; receiving the query from a user; and sending the question to the user.

16. The method of sentence 15 further comprising receiving a response from the user indicating that the user is interested in the product; and providing an advertisement for the product.

17. The method of sentence 16 where the advertisement comprises a link to another website.

18. The method of sentence 16 where the advertisement is included as part of or in addition to other search results.

19. A system comprising: a search engine configured to receive a search query from a user and output a search result to the user; a user interface configured to allow a user to send a search query to the search engine; a survey program configured to provide survey questions in response to the user query, the survey questions being configured to identify an advertiser's product in which the user has an interest; a user interface configured to allow a user to respond to one or more of the survey questions; and an ad service configured to provide advertising related to the identified product to the user.

20. The system of sentence 19 further comprising a tracking program configured to determine when a user purchases the product in response to the advertising.

21. The system of sentence 20 further comprising a compensation program configured to charge the advertiser a fee each time a user purchases the product in response to the advertising.

22. The system of sentence 19 where the ad service provides advertising via email.

23. The system of sentence 19 where the ad service provides advertising via a postal service.

24. The system of sentence 19 where the ad service provides advertising via a telephone.

25. The system of sentence 19 where the ad service provides advertising via a search result item including a link to a webpage advertising the product.

26. The system of sentence 25 further comprising a tracking program configured to determine when a user has selected the link.

27. The system of sentence 26 further comprising a compensation program configured to charge the advertiser a fee each time a user selects the link.

28. The system of sentence 27 wherein the tracking program is further configured to determine when a user has fulfilled success criteria.

29. The system of sentence 27 wherein the tracking program is further configured to determine when a user has purchased the product from the webpage.

30. A method comprising: sending a search query to a search engine; receiving a survey questionnaire in response to the search query; responding to the survey questionnaire; and receiving directed advertising based on the responses to the survey questionaire.

31. The method of sentence 30 wherein the step of receiving directed advertising comprises receiving a link to an advertiser's website.

32. The method of sentence 31 further comprising following the link to the advertiser's website.

33. The method of sentence 32 further comprising purchasing a product from the advertiser.

34. The method of sentence 30 wherein the link includes a promotional offer.

35. The method of sentence 34 further comprising following the link to the advertiser's website.

36. The method of sentence 35 further comprising purchasing a product form the advertiser.

37. The method of sentence 36 further comprising receiving a benefit from the promotional offer.

38. A method comprising: providing a database of products, wherein each product is associated with a keyword; receiving, from a user, a search query including a keyword associated with a given product; asking the user a question related to the product; and providing the user with product advertising, based on the received response.

39. The method of sentence 38 wherein providing the user with product advertising comprises providing the user with a link to an advertiser's website advertising the product.

40. The method of sentence 38 wherein providing the user with product advertising comprises directing the user to a website advertising the product.

41. The method of sentence 39 further comprising determining how often the link is clicked when provided in response to a search query including the keyword.

42. The method of sentence 41 further comprising charging a fee to the advertiser each time the link is clicked.

43. The method of sentence 39 further comprising charging a fee to the advertiser for associating the advertiser with a keyword.

44. The method of sentence 38 wherein providing the user with product advertising comprises providing the user with a list of products available for sale.

45. A method comprising providing a web advertisement; and associating the web advertisement with a survey program configured to: provide a survey question to a user in response to a search query; receive a response to the survey question from the user; determine a product in which the user may have an interest based on the user's response to the survey questions; and provide the user with a link to the web advertisement.

46. The method of sentence 45 further comprising providing an incentive to the user if the user has accessed the website via the link and the user meets the website's success criteria.

47. The method of sentence 45 where the website's success criteria is the purchase of a product.

48. The method of sentence 45 where the survey program is provided by a third party.

49. The method of sentence 45 further comprising paying a fee to the third party each time a user accesses the web advertisement via the link.

50. The method of sentence 45 further comprising paying a fee to the third party each time a user accesses the web advertisement via the link and makes a purchase.

51. The method of sentence 48 wherein the step of associating the web advertisement with a survey program comprises paying the third party for the right to associate the web advertisement with a keyword.

52. The method of sentence 48 wherein the step of associating the web advertisement with a survey program comprises providing the third party with a bid for the right to associate the web advertisement with a keyword.

53. The method of sentence 48 wherein the step of associating the web advertisement with a survey program comprises providing one or more survey questions to be associated with the web advertisement.

54. The method of sentence 48 wherein the step of associating the web advertisement with a survey program comprises providing one or more keywords to be associated with the web advertisement.

55. A method comprising: providing a web advertisement including a survey question; providing a database of advertisers who have provided compensation to have their advertisements associated with the web advertisement, where each advertiser in the database is associated with a possible answer to the survey question; receiving an answer to the survey question from a searcher; determining which, if any, of the advertisers in the database are associated with the answer given by the searcher; providing the searcher with a list of advertisers who are associated with the searcher's answer.

56. The method of sentence 55 wherein advertisers who have provided compensation comprises advertisers who have promised to pay compensation if a searcher satisfies success criteria.

57. The method of sentence 56 wherein success criteria comprises purchasing a product.

58. The method of sentence 56 wherein success criteria comprises visiting the advertiser's website.

59. The method of sentence 56 wherein success criteria comprises following a link embedded in the list to the advertiser's website.

60. The method of sentence 561 wherein success criteria comprises visiting the advertiser's premises.

61. The method of sentence 55 wherein the list is in the form of an email.

62. The method of sentence 55 wherein the list is in the form of a text message.

63. The method of sentence 55 wherein the list is provided in a website.

64. The method of sentence 55 wherein the list is provided in a popup window.

65. The method of sentence 55 wherein the list includes an embedded link to an advertiser's website.

66. The method of sentence 55 further comprising later providing an updated list.

67. The method of sentence 66 where the updated list includes advertisers who were not included in the first list.

68. The method of sentence 55 wherein the advertisement includes a plurality of survey questions.

69. A method comprising receiving a search query including a keyword; providing an advertisement in response to the search query, wherein the advertisement includes a promotional offer valid if the searcher follows a link embedded in the advertisement and satisfies additional success criteria; determining if the searcher satisfied the additional success criteria; determining if the searcher followed the link embedded in the advertisement prior to satisfying the additional success criteria; awarding the promotional offer if the searcher satisfied the additional success criteria and followed the link embedded in the advertisement prior to satisfying the additional success criteria.

70. The method of sentence 69 wherein the success criteria is the purchase of a product.

71. The method of sentence 69 further comprising providing a survey question in response to the keyword.

72. The method of sentence 71 further comprising receiving a response to the survey question and wherein the advertisement is provided based on the response to the survey question.

73. A system comprising: an advertiser database comprising: a list of advertisers; and, for each advertiser: a keyword; and a search question associated with the keyword; and a search program configured to identify a search query and determine if the search query includes a keyword in the advertiser database.

74. The system of sentence 73 wherein if the search program determines that the search query includes a keyword in the advertiser database, the search program is further configured to identify a question associated with the keyword as a matched question.

75. The system of sentence 74 wherein the search program is configured to provide a matched question to the searcher.

76. The system of sentence 75 wherein if the search program identifies more than one matched question, the search program is configured to provide a subset of the matched questions to the searcher.

77. The system of sentence 75 wherein the search program is further configured to receive an answer to the matched question from the searcher.

78. The system of sentence 77 wherein the search program is further configured to provide information about the advertiser with whom the question and keyword were associated in response to the searcher's answer.

79. The system of sentence 78 wherein information about the advertiser comprises a link to the advertiser's website.

80. The system of sentence 73 wherein, for each advertiser, the advertiser database further comprises an expected answer for each search question.

81. The system of sentence 80 wherein the search engine is configured to provide information about the advertiser to the searcher only if the searcher answers the question with the expected answer.

82. The system of sentence 73 wherein the advertiser database further comprises, for each advertiser, a maximum amount that will be paid by the advertiser each time the advertiser's information is provided to the searcher.

83. The system of sentence 73 wherein the advertiser database further comprises, for each advertiser, a maximum amount that will be paid by the advertiser for each completion of a success criteria by a searcher.

84. The system of sentence 84 wherein the success criteria is clicking on a link to the advertiser's website.

85. The system of sentence 84 wherein the success criteria is purchasing a product from the advertiser.

86. A method comprising: determining a keyword; determining that the keyword has been associated with a first advertisement; determining a first question to be asked by a search engine in response to a search query including the keyword; determining a first response which, if provided in response to the first question, will trigger the display of the first advertisement.

87. The method of sentence 86 further comprising determining an amount to pay for associating the first advertisement with the keyword.

88. The method of sentence 86 further comprising determining an amount to pay for the first question to be asked.

89. The method of sentence 87 further comprising determining a maximum amount to pay during a given time period for the first question to be asked.

90. The method of sentence 10 further comprising determining an amount to pay for the advertisement to be displayed.

91. The method of sentence 90 further comprising determining a maximum amount to pay during a given time period for the advertisement to be displayed.

92. The method of sentence 86 further comprising determining a second response which, if provided in response to the question, will not trigger the display of the first advertisement.

93. The method of sentence 86 further comprising determining a second question to be asked by a search engine in response to a search query including the keyword.

94. The method of sentence 93 further comprising determining that they keyword has been associated with a second advertisement.

95. The method of sentence 94 further comprising determining a second response which, if provided in response to the second question will trigger the display of the second advertisement.

96. The method of sentence 93 further comprising determining a first response which, if provided in response to the first question, will trigger the display of the second question.

97. The method of sentence 86 further comprising determining a first success criteria.

98. The method of sentence 97 further comprising determining an amount to pay upon completion of the first success criteria by a searcher.

99. A method comprising: receiving from a searcher a search query including a keyword; determining a plurality of questions that could be provided to the searcher in response to the keyword; selecting a subset of the plurality of questions; providing the subset of questions to the searcher.

100. The method of sentence 99 wherein selecting a subset of the plurality of questions comprises: determining, for each question, the terms offered for providing the question to a searcher; and selecting the questions based on offered terms.

101. The method of sentence 100 wherein the offered terms comprise a price to be paid each time the question is provided to a searcher.

102. The method of sentence 100 wherein the offered terms comprise a maximum price to be paid during a time period for providing the question to a searcher.

103. The method of sentence 99 wherein selecting a subset of the plurality of questions comprises determining, for each question, a past rate of success criteria fulfillment; and selecting the question based on the past rate of success criteria fulfillment.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
determining a keyword;
determining that the keyword has been associated with a first advertisement;
determining a first question to be asked by a search engine in response to a search query including the keyword;
determining a first response which, if provided in response to the first question, will trigger the display of the first advertisement.

2. The method of claim 1 further comprising determining an amount to pay for associating the first advertisement with the keyword.

3. The method of claim 1 further comprising determining an amount to pay for the first question to be asked.

4. The method of claim 1 further comprising determining an amount to pay for the advertisement to be displayed.

5. The method of claim 1 further comprising determining a second question to be asked by a search engine in response to a search query including the keyword.

6. The method of claim 5 further comprising determining that they keyword has been associated with a second advertisement.

7. The method of claim 6 further comprising determining a second response which, if provided in response to the second question will trigger the display of the second advertisement.

8. The method of claim 5 further comprising determining a first response which, if provided in response to the first question, will trigger the display of the second question.

9. The method of claim 1 further comprising determining a first success criteria.

10. The method of claim 9 further comprising determining an amount to pay upon completion of the first success criteria by a searcher.

11. A method comprising:
receiving a search query from a user;
determining a keyword in the search query which is associated with an advertisement;
providing a survey question to the user to determine if the user is interested in the product;
receiving a response to the survey question from the user; and
providing a link to the advertisement based on the received response.

12. The method of claim 11 further comprising providing search results based on the response.

13. The method of claim 11 further comprising determining whether the user clicked on the link.

14. The method of claim 11 further comprising asking a second survey question based on the response to the first survey question.

15. The method of claim 11 further comprising providing search results based on the responses to the first and second questions.

16. The method of claim 11 wherein the step of providing a link to the advertisement comprises providing a promotional offer conditioned upon following the link.

17. A system comprising:
an advertiser database comprising:
a list of advertisers; and,
for each advertiser:
a keyword; and
a search question associated with the keyword; and
a search program configured to identify a search query and determine if the search query includes a keyword in the advertiser database.

18. The system of claim 17 wherein, for each advertiser, the advertiser database further comprises an expected answer for each search question.

19. The system of claim 18 wherein the search engine is configured to provide information about the advertiser to the searcher only if the searcher answers the question with the expected answer.

20. The system of claim 19 wherein the advertiser database further comprises, for each advertiser, a maximum amount that will be paid by the advertiser each time the advertiser's information is provided to the searcher.
